(19) United States
(12) Patent Application Publication
(10) Pub. No.: US 2007/0035244 A1
(43) Pub. Date: Feb. 15, 2007

(54) Plasma display panel (PDP)

(76) Inventors: Dong-Young Lee, Suwon-si (KR); Won-Ju Yi, Suwon-si (KR); Ho-Young Ahn, Suwon-si (KR); Kyoung-Doo Kang, Suwon-si (KR); Soo-Ho Park, Suwon-si (KR); Seok-Gyun Woo, Suwon-si (KR); Jae-Ik Kwon, Suwon-si (KR)

Correspondence Address: Robert E. Bushnell, Suite 300, 1522 K Street, N.W., Washington, DC, 20005, US

(21) Appl. No.: 11/498,775

(22) Filed: Aug. 4, 2006

(30) Foreign Application Priority Data
Aug. 9, 2005 (KR) 10-2005-0072964

(51) Int. Cl. H01J 1/62

(52) U.S. Cl. 313/512

(57) ABSTRACT

A Plasma Display Panel (PDP) that can be easily manufactured and reduces damages caused by thermal expansion includes: a first substrate and a second substrate arranged opposite to and spaced apart from each other; an electrode sheet arranged between the first substrate and the second substrate and having barrier ribs partitioning discharge cells and pairs of discharge electrodes adapted to cause a discharge in the discharge cells; and fixing members arranged on sides of the electrode sheet and adapted to fix the electrode sheet between the first substrate and the second substrate.

### CLAIM OF PRIORITY

This application makes reference to, incorporates the same herein, and claims all benefits accruing under 35 U.S.C. § 119 from an application for PLASMA DISPLAY PANEL earlier filed in the Korean Intellectual Property Office on 9 Aug. 2005 and there duly assigned Serial No. 10-2005-0072964.

### BACKGROUND OF THE INVENTION

1. Field of the Invention

The present invention relates to a Plasma Display Panel (PDP) having a new structure.

2. Description of the Related Art

Plasma Display Panels (PDPs) have recently replaced conventional Cathode Ray Tube (CRT) displays. In a PDP, a discharge gas is sealed between two substrates on which a plurality of discharge electrodes are formed, a discharge voltage is applied, phosphors formed in a predetermined pattern are excited by ultraviolet rays generated by the discharge voltage to obtain a desired image.

A conventional Plasma Display Panel (PDP) having a similar structure to a PDP referred to in Japanese Laid-open Patent Publication No. 1998-172442 includes a first substrate, a plurality of pairs of sustain electrodes disposed on the first substrate, a first dielectric layer that covers the pairs of sustain electrodes, a protective layer that covers the first dielectric layer, a second substrate that is opposite to the first substrate, a plurality of address electrodes disposed on the second substrate to be parallel to one another, a second dielectric layer that covers the address electrodes, barrier ribs formed on the second dielectric layer, and phosphor layers formed on a top surface of the second dielectric layer and on both sides of the barrier ribs.

However, in the conventional PDP, a considerable portion (about 40%) of visible light rays emitted from the phosphor layer is absorbed by the pairs of sustain electrodes, the first dielectric layer, and the protective layer. In addition, when the conventional three-electrode surface discharge-type PDP displays the same image for a long time, the phosphor layers are ion-sputtered by charged particles of the discharge gas whereby permanent image sticking is formed.

To solve the problem, Korean Laid-open Patent Publication No. 2005-40635 refers to a PDP in which discharge electrodes are disposed at the sides of barrier ribs to cause a discharge, thereby improving brightness and luminous efficiency. In the case of the PDP having the above structure, since the discharge electrodes are disposed at the sides of the barrier ribs, a method of manufacturing the PDP is complicated.

### SUMMARY OF THE INVENTION

The present invention provides a Plasma Display Panel (PDP) that can be simply manufactured.

The present invention also provides a PDP that reduces damages caused by thermal expansion.

According to an aspect of the present invention, a PDP is provided, the PDP including: a first substrate and a second substrate arranged opposite to and spaced apart from each other; an electrode sheet arranged between the first substrate and the second substrate and having barrier ribs partitioning discharge cells and pairs of discharge electrodes adapted to cause a discharge in the discharge cells; and fixing members arranged on sides of the electrode sheet and adapted to fix the electrode sheet between the first substrate and the second substrate.

The fixing members are preferably symmetrical with the electrode sheet. The fixing members preferably surround the electrode sheet. The electrode sheet preferably has a rectangular flat panel shape, and the fixing members are preferably arranged to correspond to at least two opposite vertices of the electrode sheet. The fixing members are alternatively preferably arranged to correspond to each of four vertices of the electrode sheet.

The electrode sheet preferably has a rectangular flat panel shape, and the fixing members are preferably arranged to correspond to at least two edges of the electrode sheet. The fixing members are alternatively preferably arranged to correspond to each of four edges of the electrode sheet.

The fixing members are preferably fixed on at least one of the first substrate and the second substrate.

The PDP preferably further includes a sealing member surrounding the electrode sheet and the fixing members and adapted to bond the first substrate to the second substrate. The sealing member preferably includes frit glass.

The discharge electrodes are preferably arranged within the barrier ribs. Each of the discharge electrodes preferably extends to surround the discharge cells disposed in one direction. Each of the pairs of discharge electrodes preferably includes a first discharge electrode and a second discharge electrode, the first discharge electrode and the second discharge electrode extending to cross each other. Each of the pairs of discharge electrodes alternatively preferably includes a first discharge electrode and a second discharge electrode, the first discharge electrode and the second discharge electrode extending to be parallel each other.

The PDP preferably further includes address electrodes extending to cross the pairs of discharge electrodes. The address electrodes are preferably arranged within the barrier ribs and extend to surround the discharge cells disposed in one direction.

The PDP preferably further includes grooves arranged on at least one of the first substrate and the second substrate, the grooves corresponding to the discharge cells.

The PDP preferably further includes phosphor layers arranged within the grooves.

The barrier ribs preferably include a dielectric substance.

A thermal expansion coefficient of the electrode sheet is preferably less than thermal expansion coefficients of the first substrate and the second substrate.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a conventional Plasma Display Panel (PDP);

FIG. 2 is an exploded perspective view of a PDP according to an embodiment of the present invention;

FIG. 3 is a plan view from an upper portion of FIG. 2;

FIG. 4 is a cross-sectional view taken along line IV-IV of FIG. 2;

FIG. 5 is a partially-enlarged perspective view of the PDP of FIG. 2;

FIG. 6 is a cross-sectional view of the PDP taken along line VI-VI of FIG. 5;

FIG. 7 is a layout diagram of the discharge cells and first and second discharge electrodes of FIG. 5;

FIG. 8 is a cross-sectional view of a structure of the PDP when the PDP of FIG. 2 has a three-electrode structure;

FIG. 9 is a layout diagram of the discharge cells, first and second discharge electrodes, and address electrodes of FIG. 8;

FIG. 10 is a schematic graph of temperature in a sealing furnace verse time during a sealing process;

FIGS. 11A through 11C are schematic cross-sectional views of a thermal expansion state of the PDP with respect to time during the sealing process;

FIG. 12 is a plan view of a PDP according to another embodiment of the present invention;

FIG. 13 is a plan view of a PDP according to another embodiment of the present invention; and

FIG. 14 is a plan view of a PDP according to another embodiment of the present invention.

### DETAILED DESCRIPTION OF THE INVENTION

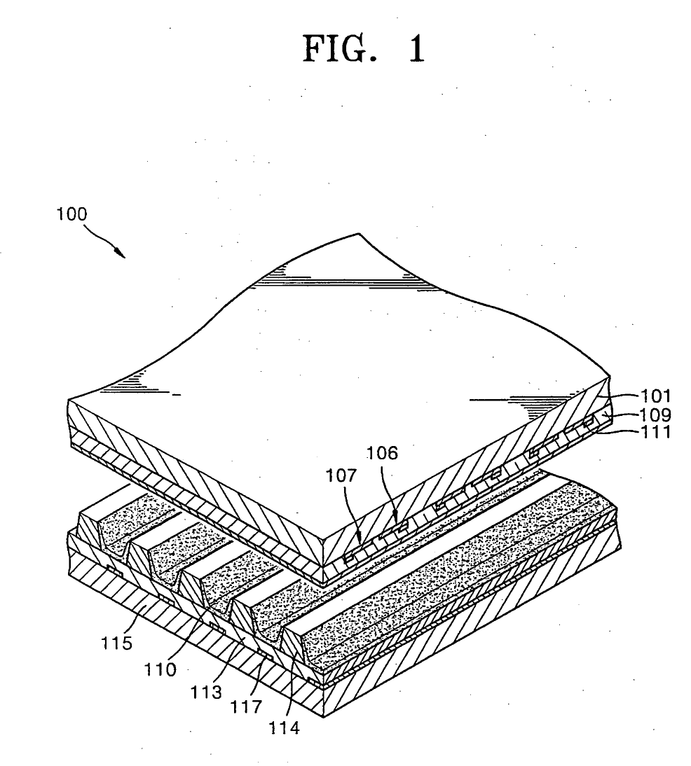

FIG. 1 is an exploded perspective view of a conventional PDP (PDP) 100 having a similar structure to a PDP 100 referred to in Japanese Laid-open Patent Publication No. 1998-172442. The PDP 100 includes a first substrate 101, a plurality of pairs of sustain electrodes 106 and 107 disposed on the first substrate 101, a first dielectric layer 109 that covers the pairs of sustain electrodes 106 and 107, a protective layer 111 that covers the first dielectric layer 109, a second substrate 115 that is opposite to the first substrate 101, a plurality of address electrodes 117 disposed on the second substrate 115 to be parallel to one another, a second dielectric layer 113 that covers the address electrodes 117, barrier ribs 114 formed on the second dielectric layer 113, and phosphor layers 110 formed on a top surface of the second dielectric layer 113 and on both sides of the barrier ribs 114.

However, in the conventional PDP 100, a considerable portion (about 40%) of visible light rays emitted from the phosphor layer 110 is absorbed by the pairs of sustain electrodes 106 and 107, the first dielectric layer 109, and the protective layer 111. In addition, when the conventional three-electrode surface discharge-type PDP 100 displays the same image for a long time, the phosphor layers 110 are ion-sputtered by charged particles of the discharge gas whereby permanent image sticking is formed.

To solve the problem, Korean Laid-open Patent Publication No. 2005-40635 refers to a PDP in which discharge electrodes are disposed at the sides of barrier ribs to cause a discharge, thereby improving brightness and luminous efficiency. In the case of the PDP having the above structure, since the discharge electrodes are disposed at the sides of the barrier ribs, a method of manufacturing the PDP is complicated.

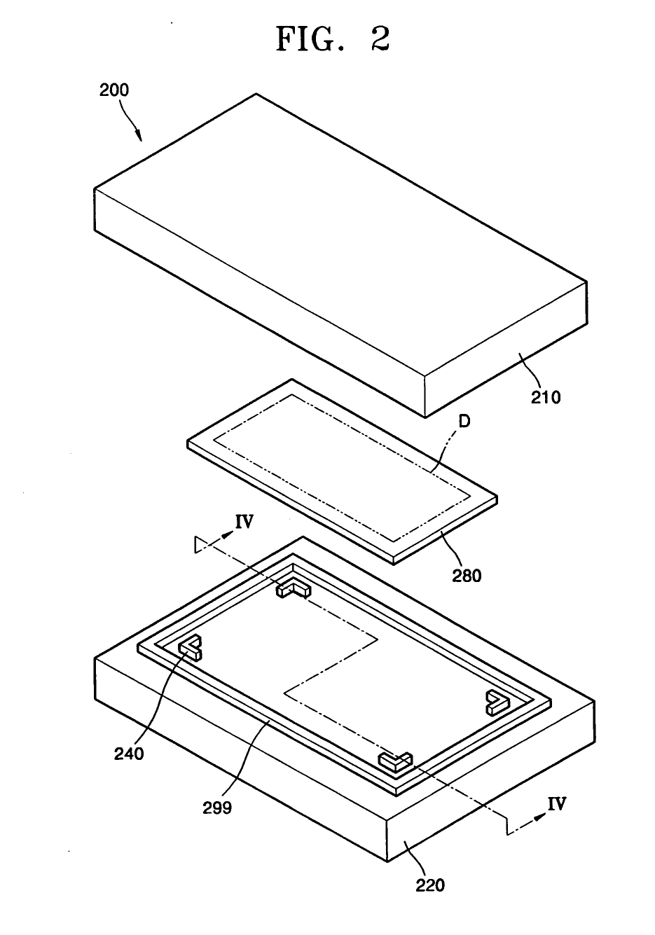

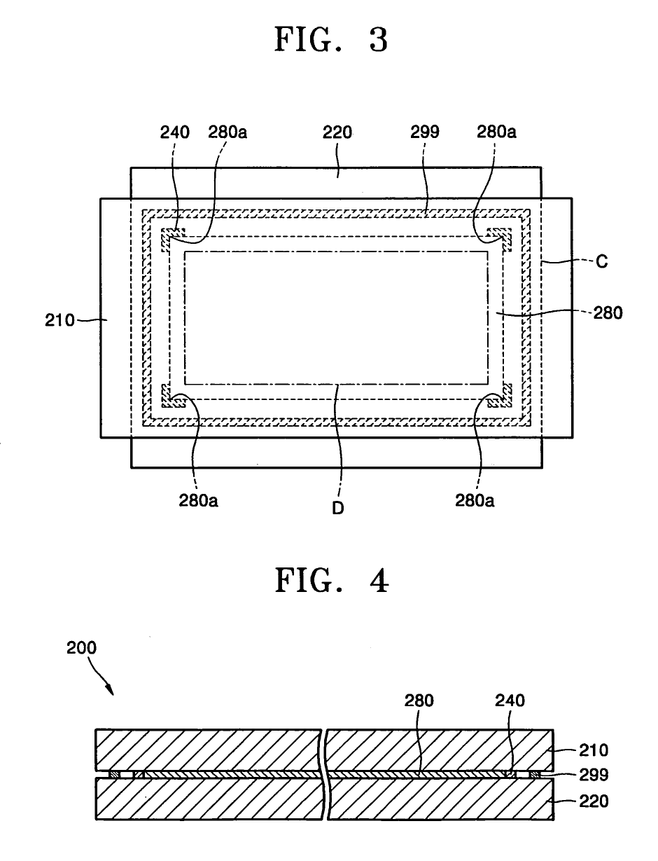

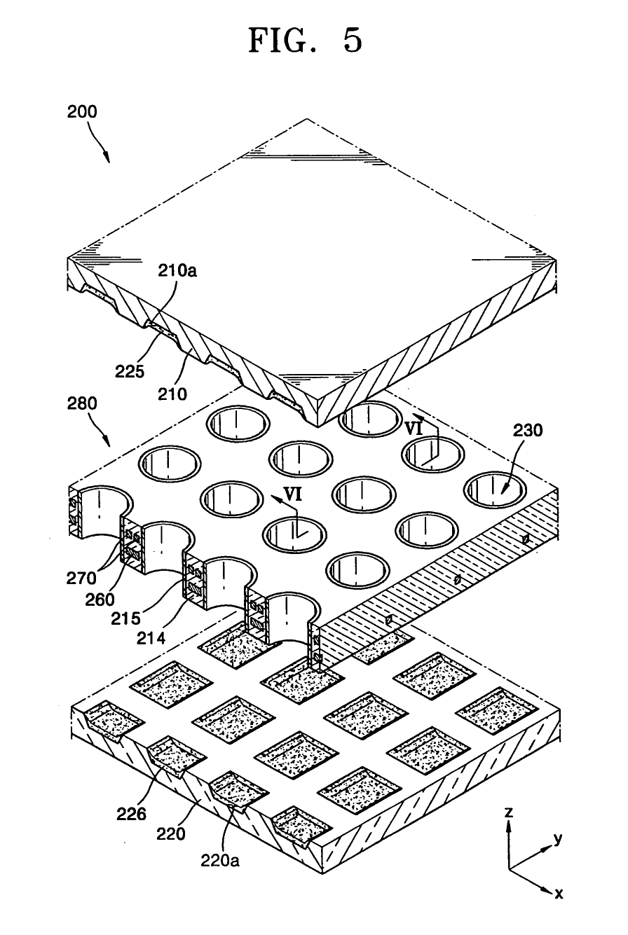

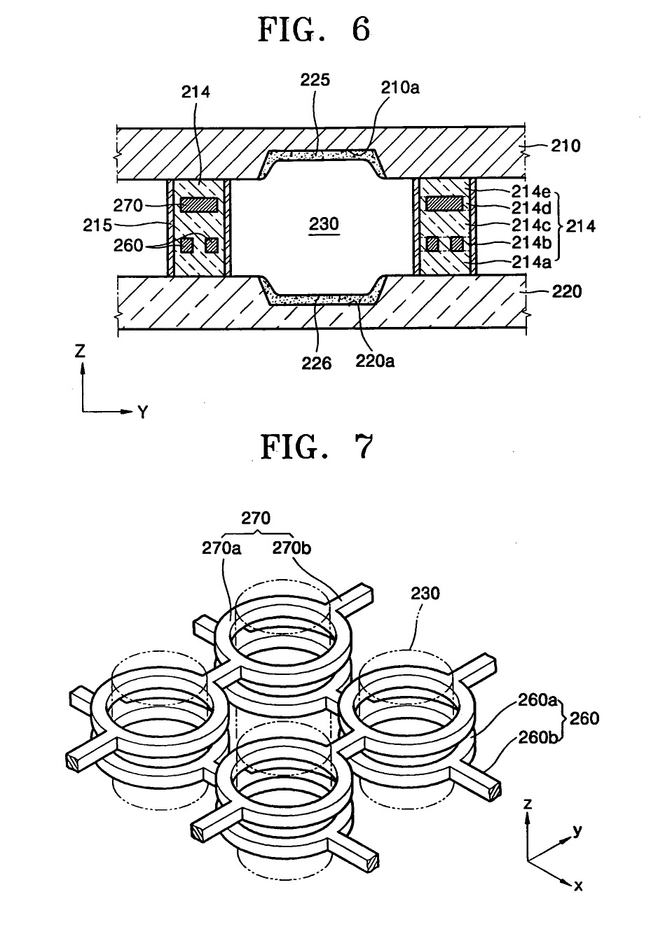

A Plasma Display Panel (PDP) 200 according to an embodiment of the present invention is illustrated in FIGS. 2 through 6. FIG. 2 is an exploded perspective view of the PDP 200 according to an embodiment of the present invention, and FIG. 3 is a plan view from an upper portion of FIG. 2. FIG. 4 is a cross-sectional view taken along line IV-IV of FIG. 2, FIG. 5 is a partially-enlarged perspective view of the PDP 200 of FIG. 2, FIG. 6 is a cross-sectional view of the PDP 200 taken along line VI-VI of FIG. 5, and FIG. 7 is a layout diagram of the discharge cells 230 and first and second discharge electrodes 260 and 270 of FIG. 5.

The PDP 200 includes a first substrate 210, a second substrate 220, an electrode sheet 280, first phosphor layers 225, second phosphor layers 226, fixing members 240, and a sealing member 299. The electrode sheet 280 has a substantially rectangular flat panel shape.

The first substrate 210 is manufactured of a material that can be mainly formed of glass and has excellent light transmission. The first substrate 210 can be colored so as to reduce reflection brightness to improve contrast in a bright room. In addition, the second substrate 220 is separated from the first substrate 210 by a predetermined distance and opposes the first substrate 210. The second substrate 220 defines a plurality of discharge cells 230 together with the first substrate 210 and the electrode sheet 280. The second substrate 220 is manufactured of a material having excellent light transmission, such as glass. The second substrate 220 can also be colored as in the first substrate 210. In addition, the first substrate 210 and the second substrate 220 can be formed of the same material. A thermal expansion coefficient of the first substrate 210 is the same as that of the second substrate 220.

Visible light rays emitted by the discharge cells 230 can be emitted through the first substrate 210 and/or the second substrate 220. Since the sustain electrodes 106 and 107, the first dielectric layer 109, and the protective layer 111 that have existed on the first substrate 101 of the PDP 100 of FIG. 1 do not exist on the first substrate 210 and/or the second substrate 220, forward transmission of visible light rays is remarkably improved. Thus, when the PDP 200 displays images with conventional brightness, the first and second discharge electrodes 260 and 270 can be driven with a lower voltage.

Referring to FIGS. 5 through 7, the electrode sheet 280 includes barrier ribs 214 that partition the discharge cells 230. The barrier ribs 214 partition the discharge cells 230 having circular cross-sections. However, the present invention is not limited to this. That is, the barrier ribs 214 can be formed in various patterns as long as the barrier ribs 214 partition the discharge cells 230. For example, the cross-sections of the discharge cells 230 can have circular shapes, or polygonal shapes such as triangular, rectangular or pentagonal shapes or elliptical shapes.

The electrode sheet 280 includes first discharge electrodes 260 and second discharge electrodes 270. Referring to FIGS. 5 and 6, the first discharge electrodes 260 and the second discharge electrodes 270 are disposed inside the barrier ribs 214. Each of the first discharge electrodes 260 makes a pair with each of the second discharge electrodes 270 and generates a discharge. Each of the first discharge electrodes 260 extends to surround the discharge cells 230 disposed along a first direction (X-direction). Each of the first discharge electrodes 260 includes first loop portions 260a that surround each of the discharge cells 230, and first loop connecting portions 260b that connect the first loop portions 260a. Each of the first loop portions 260a has a circular loop shape. However, the shape of the first loop portions 260a is not limited to this but can have various shapes such as rectangular loop shapes. The first loop portions 260a can have the same shapes as the cross-sections of the discharge cells 230.

Each of the second discharge electrodes 270 extends to surround the discharge cells 230 disposed along a second direction (Y-direction) that crosses the first direction (X-direction) in which the first discharge electrodes 260 extend. Each of the second discharge electrodes 270 is disposed to be more adjacent to the first substrate 210 than the first discharge electrodes 260. However, the present invention is not limited to this. Each of the second discharge electrodes 270 includes second loop portions 270a that surround the discharge cells 230, and second loop connecting portions 270b that connect the second loop portions 270a. Each of the second loop portions 270a has a circular loop shape. However, each of the second loop portions 270a is not limited to this and the second loop portions 270a can have various shapes such as rectangular loop shapes. The second loop portions 270a can have the same shapes as the cross-sections of the discharge cells 230.

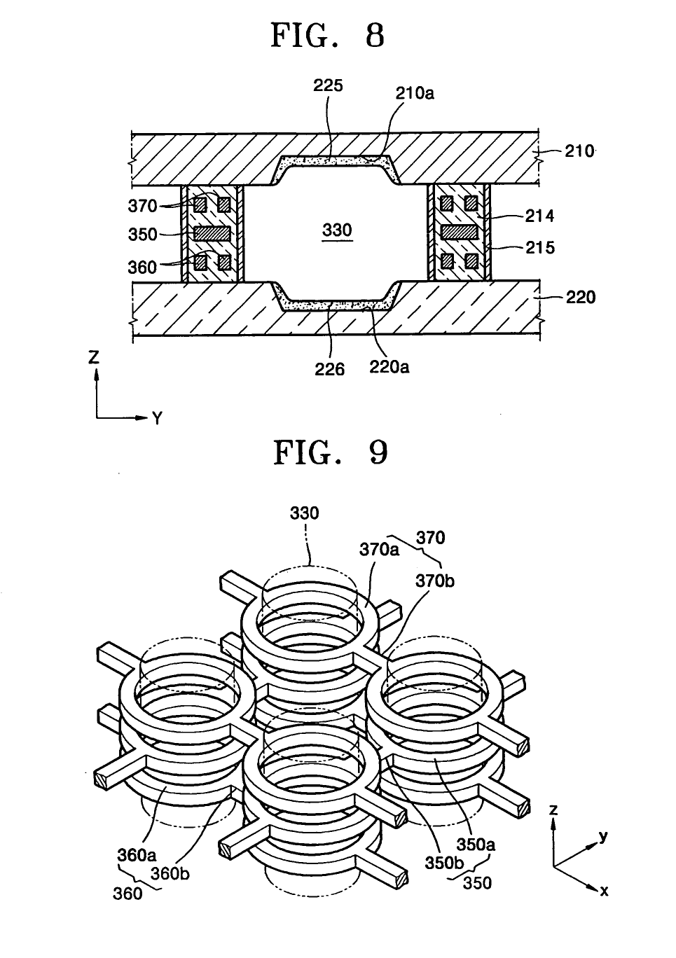

The PDP 200 forms a two-electrode structure. That is, one of the first discharge electrode 260 and the second discharge electrode 270 serves as a scan and sustain electrode, and the other thereof serves an addressing and sustain electrode. However, the present invention is not limited to the two-electrode structure and can have a three-electrode structure. FIGS. 8 and 9 are views of an example of a three-electrode PDP. Like reference numerals in the above-mentioned embodiment represent like elements. Each of the first discharge electrodes 360 makes a pair with each of the second discharge electrodes 370, generates a discharge in discharge cells 330 and extends to be parallel to each of the second discharge electrodes 370. Each of the first discharge electrodes 360 includes first loop portions 360a that surround each of the discharge cells 330 disposed in a first direction (X-direction), and first loop connecting portions 360b that connect the first loop portions 360a. Each of the second discharge electrodes 370 includes first loop portions 370a that surround each of the discharge cells 330 disposed in a first direction (X-direction), and first loop connecting portions 370b that connect the first loop portions 370a. In addition, a plurality of address electrodes 350 extend to cross a direction in which the first discharge electrodes 360 and the second discharge electrodes 370 extend. The address electrodes 350 are separated from the first and second discharge electrodes 360 and 370 by predetermined distance in a direction perpendicular to the first substrate 210 (z-direction) in the barrier ribs 214. Each of the address electrodes 350 includes third loop portions 350a that surround each of the discharge cells 330, and third loop connecting portions 350b that connect the third loop portions 350a. In order to reduce an address discharge voltage, the second discharge electrodes 370, the address electrodes 350, and the first discharge electrodes 360 are sequentially disposed in the direction perpendicular to the first substrate 210. However, the present invention is not limited to this. The address electrodes 350 can be disposed to be closest to the first substrate 210 or farthest thereto. Alternatively, the address electrodes 350 can be disposed on the second substrate 220. The address electrodes 350 are used to generate an address discharge in order to perform a sustain discharge between the first discharge electrodes 360 and the second discharge electrodes 370 more easily. More specifically, the address electrodes 350 reduce the voltage required for the sustain discharge. The address discharge occurs between scan electrodes and address electrodes. If the address discharge is terminated, positive ions are accumulated on the scan electrodes and electrons are accumulated on common electrodes such that a sustain discharge between the scan electrodes and the common electrodes is more easily performed. The first discharge electrodes 360 serve as scan electrodes, and the second discharge electrodes 370 serve as common electrodes. However, the present invention is not limited to this.

In the above-described embodiments, the PDP 200 has a two-electrode or three-electrode surface discharge structure. However, the present invention is not limited to the above-described surface discharge structure and can have an opposed discharge structure in which the first discharge electrodes and the second discharge electrodes oppose toward a middle direction of the discharge cells 330 in the barrier ribs 214. The address electrodes in which the first discharge electrodes cross the second discharge electrodes can be further disposed.

Referring to FIGS. 5 and 6, the first discharge electrodes 260 and the second discharge electrodes 270 are not disposed to directly reduce visible light transmission, and thus can be formed of a conductive metal, such as aluminum or copper. Thus, since a small voltage drop occurs in a lengthwise direction, a stable signal transmission occurs.

The first discharge electrodes 260 and the second discharge electrodes 270 are arranged in the barrier ribs 214. The barrier ribs 214 prevents electrical shorts between the adjacent first discharge electrodes 260 and the second discharge electrodes 270 during a discharge, prevents positive ions or electrons from colliding with the first discharge electrodes 260 and the second discharge electrodes 270 and prevents the first discharge electrodes 260 and the second discharge electrodes 270 from being damaged. The barrier ribs 214 can be formed of a dielectric substance that induces wall charges to accumulate.

The electrode sheet 280 includes protective layers 215 applied on adjacent portions of sides of the barrier ribs 214 to the first discharge electrodes 260 and the second discharge electrodes 270. The protective layers 215 prevent the barrier ribs 214 formed of the dielectric substance and the first and second discharge electrodes 260 and 270 from being damaged by the sputtering of plasma particles, and reduce a discharge voltage by emitting secondary electrons. Magnesium oxide (MgO) is applied on the sides of the barrier ribs 214 to a predetermined thickness to form the protective layers 215.

The fixing members 240 are closely adhered to the electrode sheet 280. The fixing members 240 have cross-sections substantially bent at 90 degrees, for example, “L”-shaped cross-sections, and correspond to each of four vertices 280a of the electrode sheet 280. The electrode sheet 280 is fixed between the first substrate 210 and the second substrate 220 so as not to move therebetween, using the fixing members 240. According to the current embodiment of the present invention, the fixing members 240 have similar shapes. For example, the fixing members 240 are symmetrical with the electrode sheet 280. However, the present invention is not limited to this and the fixing members 240 have only to fix the electrode sheet 280. In order to increase a fixing force generated by the fixing members 240, the fixing members 240 can be disposed at opposite sides of the electrode sheet 280. The fixing members 240 can be formed of various materials. In addition, the fixing members 240 are fixed on the first substrate 210 and/or the second substrate 220 using frit glass.

The PDP 200 further includes the first phosphor layers 225 and the second phosphor layers 226. More specifically, first grooves 210a are formed on the first substrate 210 that opposes the discharge cells 230. The first grooves 210a are discontinuously formed in each of the discharge cells 230, and the first phosphor layers 225 are disposed in the first grooves 210a. Similarly, second grooves 220a are discontinuously formed on the second substrate 220 that opposes the discharge cells 230. The second phosphor layers 226 are disposed in the second grooves 220a. The positions of the first phosphor layers 225 and the second phosphor layers 226 are not limited to those described above and the layers can be disposed in various positions. For example, the first phosphor layers 225 or the second phosphor layers 226 can be disposed on the sides of the barrier ribs 214 in which the protective layers 215 are not formed. The first and second phosphor layers 225 and 226 have components for generating visible light rays in response to ultraviolet light rays. The phosphor layers 225 and 226 formed in red discharge cells include phosphors such as Y(V,P)O₄:Eu, the phosphor layers 125 and 126 formed in green discharge cells include phosphors such as Zn₂SiO₄:Mn, and the phosphor layers 125 and 126 formed in blue discharge cells include phosphors such as BAM:Eu.

A sealing member 299 is interposed between the first substrate 210 and the second substrate 220. The sealing member 299 surrounds the electrode sheet 280 and the fixing members 240 while not contacting the electrode sheet 280 and the fixing members 240. The sealing member 299 bonds boundaries of the first substrate 210 and the second substrate 220 to each other. The discharge cells 230 are sealed using the sealing member 299. The sealing member 299 can be formed of various materials, for example, a material including frit glass.

The size of the electrode sheet 280 and an area in which the sealing member 299 is disposed can be selected in various ways. For example, the barrier ribs 214 of the electrode sheet 280 do not include additional dummy barrier ribs and define only the discharge cells 230. In this case, the electrode sheet 280 can correspond to a display area D. The sealing member 299 can be disposed between the display area D and an outline C in which the first substrate 210 and the second substrate 220 overlap. In this structure, since the sealing member 299 and the electrode sheet 280 do not directly contact each other, the electrode sheet 280 is prevented from being contaminated by the sealing member 299 during a sealing process. In addition, since the barrier ribs 214 of the electrode sheet 280 do not include additional dummy barrier ribs, the amount of materials needed to form the barrier ribs 214 is reduced such that costs are reduced.

A method of manufacturing the PDP 200 having the above structure is described below. First, the first substrate 210, the second substrate 220, and the electrode sheet 280 are prepared. Next, the first substrate 210 and the second substrate 220 are etched or sand-blasted, thereby forming the first grooves 210a and the second grooves 220a. After that, pastes for the first phosphor layers 225 and the second phosphor layers 226, respectively, are applied, dried and fired. The fixing members 240 for fixing the electrode sheet 280 are fixed on the first substrate 210 or the second substrate 220 using a material such as frit glass. The electrode sheet 280 can be manufactured using various methods, for example, using the following method. Referring to FIG. 6, first, a dielectric sheet 214a, a dielectric sheet 214b formed on which the first discharge electrodes 260 are formed, a dielectric sheet 214c, a dielectric sheet 214d on which the second discharge electrodes 270 are formed, and a dielectric sheet 214e are sequentially stacked, and then dried and fired. After that, the protective layers 215 are deposited and the electrode sheet 280 is formed. Since the electrode sheet 280 can be formed using similar processes as described above, a method of manufacturing the PDP 200 is greatly simplified. After the first substrate 210, the second substrate 220, and the electrode sheet 280 are prepared, the electrode sheet 280 is seated in a space surrounded by the fixing members 240 and then the sealing member 299 is applied and seals the first and second substrates 210 and 220. Next, an exhaust/discharge gas injection process is consecutively performed, thereby manufacturing the PDP 200. After the exhaust/discharge gas injection process, various post-processing operations such as aging can be performed. Thus, the PDP 200 can be manufactured using the above-described method such that the number of processes is reduced, processes are simplified and the PDP 200 can be very easily manufactured.

In general, there is the possibility of damages caused by a thermal expansion coefficient difference between components. However, in the case of the PDP 200 of FIG. 2, the possibility of damages caused by thermal expansion is greatly reduced, is described in detail as follows using a sealing process of the PDP 200 which is one of processes in which temperature rises up to the maximum. Thermal expansion coefficients of the first and second substrates 210 and 220 are larger than a thermal expansion coefficient of the electrode sheet 280. Only, the present invention is not limited to this.

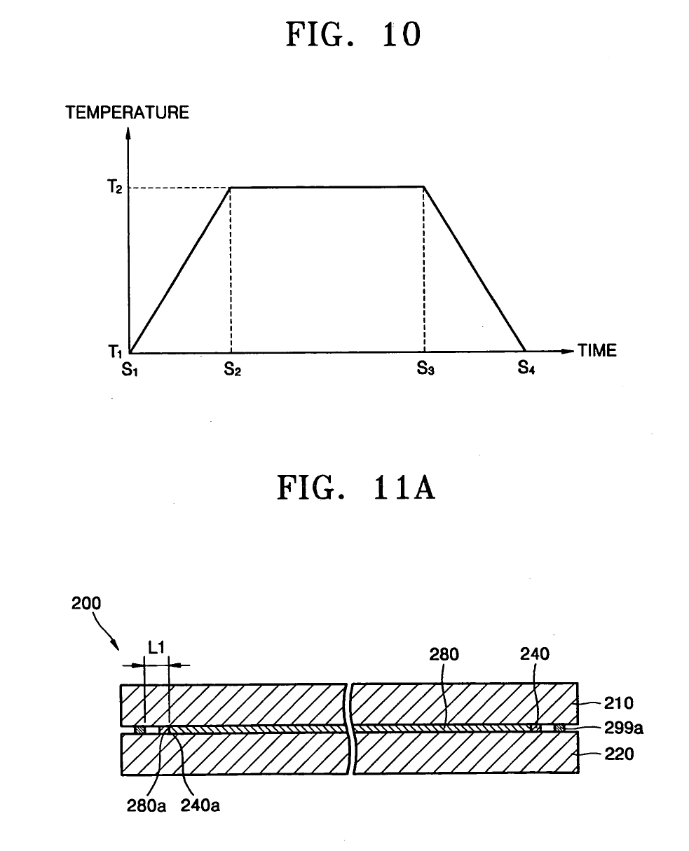

A change of temperature in a sealing furnace according to time during the sealing process is shown in FIG. 10. Referring to FIG. 10, a firing furnace is heated from first time S₁ to second time S₂ whereby temperature increases from a first temperature T₁ to a second temperature T₂. After that, the temperature increases up to third time S₃ and is substantially maintained at the second temperature T₂. Then, the temperature is lowered up to the first temperature T₁ between the third time S₃ and the fourth time S₄. In the case of the second temperature T₂, the temperature in the sealing furnace can be changed according to material characteristics of the sealing member 299. However, the temperature of the sealing furnace is generally high, that is about 450° C.

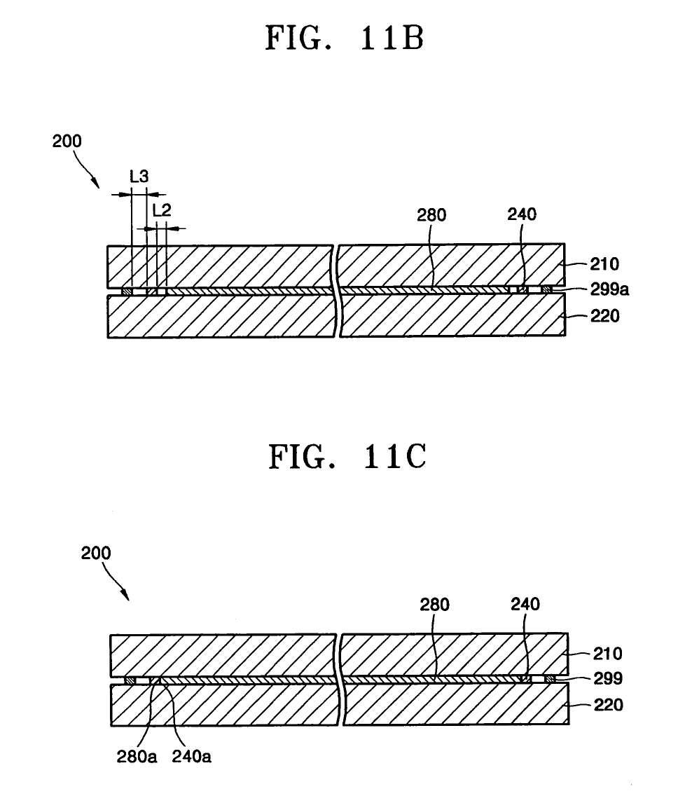

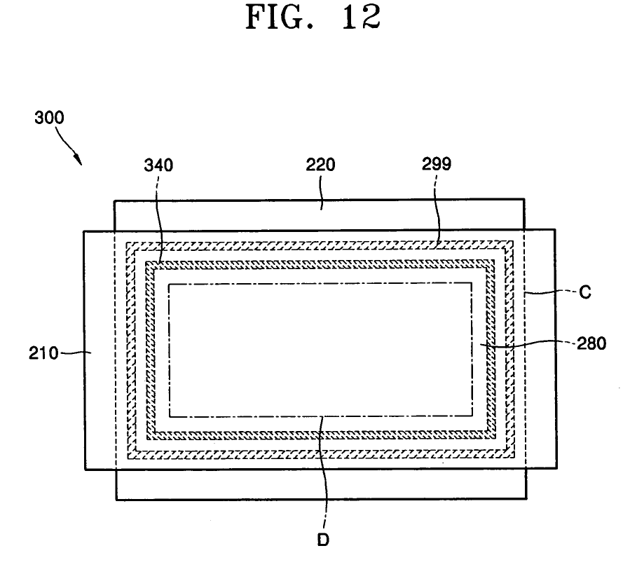

FIGS. 11A through 11C are schematic cross-sectional views of a thermal expansion state of the PDP 200 with respect to time during the sealing process.

FIG. 11A is a schematic cross-sectional view of the PDP 200 at first time S₁. Referring to FIG. 11A, the electrode sheet 280 is closely adhered to the fixing members 240 and thus does not move between the first substrate 210 and the second substrate 220. In addition, a paste 299a for the sealing member 299 is applied to surround the circumference of the electrode sheet 280. Thus, since the paste 299a for the sealing member 299 and the electrode sheet 280 are spaced apart from each other by a first distance L1, the electrode sheet 280 is prevented from being contaminated by the paste 299a for the sealing member 299.

FIG. 11B is a schematic cross-sectional view of the PDP 200 at second time S₂ to third time S₃. Since the temperature of the sealing furnace increases up to the second temperature T₂, the first and second substrates 210 and 220 and the electrode sheet 280 greatly thermally expand. In particular, since thermal expansion coefficients of the first and second substrates 210 and 220 are higher than a thermal expansion coefficient of the electrode sheet 280, the first and second substrates 210 and 220 thermally expand more greatly than the electrode sheet 280. Thus, a distance L2 between the electrode sheet 280 and the fixing members 240 which have been closely adhered to each other at the first time, increases so that the possibility of damages between the electrode sheet 280 and the fixing members 240 caused by a relative thermal expansion coefficient difference is reduced. In particular, since the sealing process is performed when the first substrate 210, the second substrate 220, and the electrode sheet 280 are laid, the electrode sheet 280 is prevented from being rotated or inclined when the electrode sheet 280 and the fixing members 240 are spaced apart from each other by the distance L2. In addition, a distance L3 between the electrode sheet 280 and the paste 299a for the sealing member 299 increases so that the electrode sheet 280 is further prevented from being contaminated by contact with the paste 299a for the sealing member 299.

FIG. 11C is a schematic cross-sectional view of the PDP 200 at fourth time S₄. Since the temperature of the fourth time S₄ is the same as the temperature of the first time S₁, the first and second substrates 210 and 220 and the electrode sheet 280 return to substantially the same position as in FIG. 11A, and the electrode sheet 280 is again closely adhered to the first and second substrates 210 and 220 using the fixing members 240 and fixed. In addition, the sealing member 299 is formed using the paste 299a for sealing.

After the first substrate 210 and the second substrate 220 are sealed, a gas inside the first and second substrates 210 and 220 is exhausted and then, a discharge gas such as Ne or Xe, or a mixed gas thereof is sealed between the first and second substrates 210 and 220. A discharge surface increases and a discharge area increases so that the amount of plasma increases and low voltage driving can be performed. Thus, even though a high-concentration Xe gas is used as a discharge gas, low voltage driving can be performed whereby luminous efficiency can be remarkably improved.

A method of driving the PDP 200 having the above structure is described below.

First, an address discharge occurs between the first discharge electrodes 260 and the second discharge electrodes 270, and the discharge cells 230 in which a sustain discharge will occur as a result of the address discharge are selected. After that, if an AC sustain voltage is supplied between the first discharge electrodes 260 and the second discharge electrodes 270 of the selected discharge cells 230, a sustain discharge occurs between the first discharge electrodes 260 and the second discharge electrodes 270. The energy level of the excited discharge gas during the sustain discharge is reduced and UV light rays are emitted. The UV light rays excite the first and second phosphor layers 225 and 226 in the discharge cells 230. The energy level of the excited phosphor layers 225 and 226 is reduced, visible light is emitted, and the emitted visible light constitutes an image.

In the conventional PDP 100, a sustain discharge between the sustain electrodes 106 and 107 occurs in a horizontal direction, and a discharge area is relatively small. However, in the PDP 200 according to the current embodiment of the present invention, a sustain discharge occurs in all sides that define the discharge cells 230, and the discharge area is relatively large.

In addition, the sustain discharge according to the current embodiment of the present invention occurs in a looped curve along sides of the discharge cells 230 and gradually diffuses toward middle portions of the discharge cells 230. As a result, the volume of a region in which the sustain discharge occurs increases, and space charges in the discharge cells 230 that have not well been used in prior art also contribute to emission. Accordingly, luminous efficiency of the PDP 200 is improved. In particular, since cross-sections of the discharge cells 230 are circular shapes, the sustain discharge occurs uniformly on all sides of the discharge cells 230.

In addition, since the sustain discharge occurs only in central portions of the discharge cells 230, ion sputtering of phosphor layers caused by charged particles in the conventional PDP 100 is prevented. Thus, even when the same image is displayed for a long time, permanent image sticking is not formed.

FIG. 12 is a plan view of a PDP 300 according to another embodiment of the present invention. Like reference numerals in FIG. 2 represent like elements, and thus, detailed descriptions thereof have been omitted.

FIG. 12 is different from FIG. 2 in that fixing members 340, disposed to fix the electrode sheet 280 between the first substrate 210 and the second substrate 220, surround the electrode sheet 280. More specifically, the fixing members 340 have closed loop shapes having predetermined widths and are disposed to be closely adhered to the electrode sheet 280. The fixing members 340 are fixed on the first substrate 210 and/or the second substrate 220 using various materials such as frit glass. Thus, since a contact area between the fixing members 340 and the electrode sheet 280 increases, the electrode sheet 280 is more stably fixed between the first substrate 210 and the second substrate 220, a circumference thereof is surrounded by the sealing member 299, and a space in which the electrode sheet 280 is disposed is sealed from the outside.

FIG. 13 is a plan view of a PDP 400 according to another embodiment of the present invention. Like reference numerals in FIG. 2 represent like elements, and thus, detailed descriptions thereof have been omitted.

FIG. 13 is different from FIG. 2 in that fixing members 440, disposed to fix the electrode sheet 280 between the first substrate 210 and the second substrate 220, are closely adhered to two opposed vertices 280a of the electrode sheet 280. More specifically, the electrode sheet 280 has a rectangular flat panel shape. Thus, four vertices exist in the electrode sheet 280. The fixing members 440 are respectively disposed in the two opposed vertices 280a of the electrode sheet 280 to fix the electrode sheet 280. The fixing members 40 are attached to the first substrate 210 and/or the second substrate 220 using various materials such as frit glass. The electrode sheet 280 is fixed between the first substrate 210 and the second substrate 220. In addition, the circumference of the electrode sheet 280 is surrounded by the sealing member 299 whereby a space in which the electrode sheet 280 is disposed is sealed from the outside.

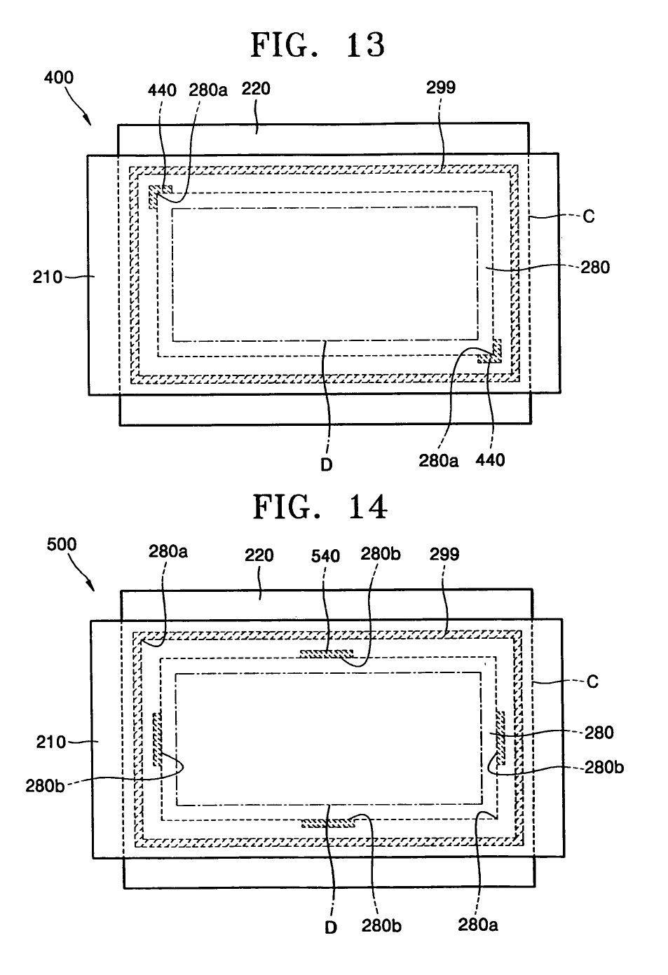

FIG. 14 is a plan view of a PDP 500 according to another embodiment of the present invention. Like reference numerals in FIG. 2 represent like elements, and thus, detailed descriptions thereof have been omitted.

FIG. 14 is different from FIG. 2 in that four fixing members 540, disposed to fix the electrode sheet 280 between the first substrate 210 and the second substrate 220, are closely adhered to opposed sides 280b of the electrode sheet 280. More specifically, the electrode sheet 280 has a rectangular flat panel shape. Thus, four edges 280b exist in the electrode sheet 280. The four fixing members 540 have predetermined depths and lengths and are attached to the first substrate 210 and/or the second substrate 220 using various materials such as frit glass. The PDP 500 in which the electrode sheet 280 is fixed with the above structure has the following effects. When the electrode sheet 280 is formed using a firing process, due to compressive stress, the angle of the four vertices 280a is not exactly 90 degrees but the four vertices 280a can be contracted into partial insides or can come off. Thus, the fixing members 540 are disposed at the opposed edges 280b of the electrode sheet 280 having relatively high flatness whereby adhesion uniformity between the electrode sheet 280 and the fixing members 540 is improved. The electrode sheet 280 is fixed between the first substrate 210 and the second substrate 220. In addition, the circumference of the electrode sheet 280 is surrounded by the sealing member 299 whereby a space in which the electrode sheet 280 is disposed is sealed from the outside.

The PDP according to the present invention has the following effects.

First, the number of processes is remarkably reduced and the processes are simplified such that the PDP can be very easily manufactured. Second, even in various thermal environment such as a high temperature process, the possibility of damages caused by thermal expansion is greatly reduced. Third, the sealing member is applied once to seal the first substrate and the second substrate such that a sealing process is simplified. Fourth, the first substrate, the second substrate, and the electrode sheet can be easily aligned using the fixing members such that manufacturing defects are reduced. Fifth, since a surface discharge can occur on all sides in which a discharge space is formed, a discharge surface can be greatly enlarged.

Sixth, since a discharge occurs on sides in which the discharge cells are formed and spreads toward middle portions of the discharge cells, a discharge area is remarkably improved compared to prior art such that the entire discharge cells are effectively used. Thus, driving can be performed at a lower voltage such that luminous efficiency is remarkably improved.

Seventh, even when a high-concentration Xe gas is used as a discharge gas, a low driving voltage can be used such that luminous efficiency is improved.

Eighth, discharge response speed is fast and a low driving voltage can be used. Since the discharge electrodes are not disposed on the first and second substrates which visible light rays transmit but are disposed at sides of the discharge space, electrodes having a low resistance, for example, metal electrodes, can be used as the discharge electrodes without the need of using transparent electrodes having a high resistance as the discharge electrodes such that discharge response speed is fast and a low driving voltage can be used without the distortion of waveforms.

Ninth, permanent image sticking can be prevented. Since an electric field caused by voltages supplied to the discharge electrodes formed on the sides of the discharge space allows the plasma to be concentrated on middle portions of the discharge space, ions generated by the discharge are prevented from colliding with phosphors by the electric field such that permanent image sticking is prevented from being formed due to ion sputtering. In particular, when a high-concentration Xe gas is used as a discharge gas, formation of permanent image sticking can be prevented.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A Plasma Display Panel (PDP) comprising:
a first substrate and a second substrate arranged opposite to and spaced apart from each other;
an electrode sheet arranged between the first substrate and the second substrate and having barrier ribs partitioning discharge cells and pairs of discharge electrodes adapted to cause a discharge in the discharge cells; and
fixing members arranged on sides of the electrode sheet and adapted to fix the electrode sheet between the first substrate and the second substrate.

2. The PDP of claim 1, wherein the fixing members are symmetrical with the electrode sheet.

3. The PDP of claim 1, wherein the fixing members surround the electrode sheet.

4. The PDP of claim 1, wherein the electrode sheet has a rectangular flat panel shape, and wherein the fixing members are arranged to correspond to at least two opposite vertices of the electrode sheet.

5. The PDP of claim 4, wherein the fixing members are arranged to correspond to each of four vertices of the electrode sheet.

6. The PDP of claim 1, wherein the electrode sheet has a rectangular flat panel shape, and wherein the fixing members are arranged to correspond to at least two edges of the electrode sheet.

7. The PDP of claim 6, wherein the fixing members are arranged to correspond to each of four edges of the electrode sheet.

8. The PDP of claim 1, wherein the fixing members are fixed on at least one of the first substrate and the second substrate.

9. The PDP of claim 1, further comprising a sealing member surrounding the electrode sheet and the fixing members and adapted to bond the first substrate to the second substrate.

10. The PDP of claim 9, wherein the sealing member comprises frit glass.

11. The PDP of claim 1, wherein the discharge electrodes are arranged within the barrier ribs.

12. The PDP of claim 1, wherein each of the discharge electrodes extends to surround the discharge cells disposed in one direction.

13. The PDP of claim 12, wherein each of the pairs of discharge electrodes includes a first discharge electrode and a second discharge electrode, the first discharge electrode and the second discharge electrode extending to cross each other.

14. The PDP of claim 12, wherein each of the pairs of discharge electrodes includes a first discharge electrode and a second discharge electrode, the first discharge electrode and the second discharge electrode extending to be parallel each other.

15. The PDP of claim 14, further comprising address electrodes extending to cross the pairs of discharge electrodes.

16. The PDP of claim 15, wherein the address electrodes are arranged within the barrier ribs and extend to surround the discharge cells disposed in one direction.

17. The PDP of claim 1, further comprising grooves arranged on at least one of the first substrate and the second substrate, the grooves corresponding to the discharge cells.

18. The PDP of claim 17, further comprising phosphor layers arranged within the grooves.

19. The PDP of claim 1, wherein the barrier ribs comprise a dielectric substance.

20. The PDP of claim 1, wherein a thermal expansion coefficient of the electrode sheet is less than thermal expansion coefficients of the first substrate and the second substrate.
